(19) United States
(12) Patent Application Publication
(10) Pub. No.: US 2026/0243124 A1
(43) Pub. Date: Aug. 20, 2026

(54) METHOD FOR OPERATING A FLAP ASSEMBLY OF A MOTOR VEHICLE

(71) Applicant: Brose Fahrzeugteile SE & Co. Kommanditgesellschaft, Bamberg, Bamberg (DE)

(72) Inventor: Sebastian Schoedel, Eckersdorf (DE)

(21) Appl. No.: 19/164,302

(22) PCT Filed: Mar. 11, 2024
(86) PCT No.: PCT/EP2024/056419

§ 371 Date: Sep. 11, 2025

(30) Foreign Application Priority Data
Mar. 14, 2023 (DE) 10 2023 106 358.8

(51) Int. Cl. E05F 15/73

(52) U.S. Cl. CPC E05F 15/73; E05Y 2400/858; E05Y 2900/546

(57) ABSTRACT

Method for operating a hatch assembly with a motorized drive assembly for opening and closing the hatch assembly, a control assembly, and a sensor assembly having at least one radar sensor are provided, wherein a contactless operating action of an operator is detected by the sensor assembly in a detection routine and the operating action is classified in a classification routine as an invalid operating action or valid operating action, wherein in the case of an invalid operating action, it is discarded and in the case of a valid operating action, a motorized opening procedure or a motorized closing procedure of the hatch assembly by the drive assembly is triggered. A following action of the operator chronologically following the operating action is detected by the sensor assembly in the detection routine and that the operating action is classified in consideration of the following action in the classification routine.

### CROSS-REFERENCE TO RELATED APPLICATIONS

This application is a national stage application under 35 U.S.C. 371 of International Patent Application Serial No. PCT/EP2024/056419, entitled “Method for Operating a Flap Assembly of a Motor Vehicle,” filed Mar. 11, 2024, which claims priority from German Patent Application No. DE 10 2023 106 358.8, filed Mar. 14, 2023, the disclosure of which is incorporated herein by reference.

### Field of the Technology

Various embodiments relate to a method for operating a hatch assembly of a motor vehicle, a control assembly, a system for operating a hatch assembly of a motor vehicle, and a motor vehicle.

### SUMMARY

Different hatch assemblies of motor vehicles can be operated using the method in discussion. A hatch assembly comprises, for example, an adjustable hatch, which can be, for example, a rear hatch, a rear cover, a front hood, in particular an engine hood, door, in particular a rear door or side door. By actuating a drive assembly assigned to the hatch assembly via a control assembly, for example, the hatch of the hatch assembly is moved from one position into another position and the hatch assembly is accordingly closed or opened in a motorized manner.

A contactless operating action, which is performed by an operator located outside the motor vehicle, is detected by the sensor assembly using at least one radar sensor. In reaction to the detected operating action, a motorized opening procedure or a motorized closing procedure of the hatch assembly by the drive assembly can be triggered. To avoid any incorrect triggering of the drive assembly, a classification routine takes place after detection of the operating action, in which the operating action is classified as an invalid operating action or valid operating action.

DE 10 2021 114 557 A1, from which some embodiments proceed, relates to a method. In the method, the movement course of the operator is determined as the movement trajectory on the basis of the sensor values detected by the sensor assembly using the radar sensor. In this case, in addition to the movement course during the operating action, the movement course before the operating action, thus a preliminary action such as an approach, is also detected.

One challenge in this method, however, is defining a suitable trajectory criterion which is as generally valid as possible.

Various embodiments are based on the problem of providing a method for operating a hatch assembly of a motor vehicle in which inadvertent incorrect triggering can be reliably avoided and the implementation of which is simplified.

The above problem is solved by various features described herein.

The fundamental consideration that the classification of the operating action takes place in consideration of a following action chronologically after the operating action can be essential. For example, the operator, after a deliberate operating action which comprises an operating gesture, for example, will wait for the hatch assembly to open or close. Accordingly, the operator will at least temporarily remain standing at the motor vehicle as a following action until the opening or closing procedure is triggered. The operator who has executed an inadvertent operating action, in contrast, will not stop a walking movement along motor vehicle and accordingly will also not remain standing as a following action, for example. It has been recognized that in the judgment of the question whether an operating action has taken place inadvertently or deliberately, the consideration of the following action can supply reliable results about the validity or invalidity of the operating action.

In detail, it is proposed that a following action of the operator which is chronologically after the operating action is detected by the sensor assembly in the detection routine and that the operating action is classified in consideration of the following action in the classification routine.

Some embodiments provide that the following action comprises the operator moving away from the vehicle and/or the operator remaining standing and that the classification of the operating action takes place in consideration of the moving away and/or the remaining standing. The moving away and the remaining standing can be detected particularly reliably via the sensor assembly, in particular provided that this takes place in a defined distance spatial segment, by which the classification by consideration can be improved accordingly.

Some embodiments provide that the classification of the operating action takes place in consideration of a characteristic following pause of the following action. The consideration of the characteristic following pause can represent an additional or alternative possibility for reliable classification.

To further improve the recognition of inadvertent operations and avoid incorrect triggering, it is provided in some embodiments that in addition to the operating action and the following action, a preliminary action chronologically preceding the operating action is detected and taken into consideration in the classification routine. One advantageous embodiment provides that the preliminary action comprises an approach of the operator to the motor vehicle, which can be reliably detected via the sensor assembly, in particular provided that this takes place in a defined approach spatial segment, and which can be taken into consideration in the classification of operating action.

In various embodiments, the classification of the operating action takes place in consideration of a characteristic preliminary pause of the preliminary action. The consideration of the characteristic preliminary pause can represent an additional or alternative possibility for reliable classification.

Various embodiments relate to the recognition of the operating action as such and the classification of the operating action via various defined criteria. The operating action can thus be reliably recognized via a defined recognition criterion in that the detected sensor values are compared thereto. The classification can also be reliably achieved in that the respective detected sensor values which are assigned to the following action and/or the preliminary action are compared with a defined following criterion and/or preliminary criterion. Moreover, the recognition and the classification can be comparatively simple to implement via defined criteria which can have different conditions.

According to some embodiments, a classification routine which is multistep if needed is provided. In this case, a second classification step only follows a first classification step if the operating action is not already classified as valid in the scope of the first classification step. The classification routine therefore has one or more classification steps as needed. The flexibility of the method can be adapted in this way in that entirely different following actions, in particular having different movement sequences, are detectable and suitable for classification.

According to some embodiments, a control assembly for a motorized drive assembly is provided. It can be essential here that the control assembly classifies the operating action in the classification routine in consideration of a following action, which is detected by the sensor assembly in the detection routine and chronologically follows the operating action. Reference can be made to all statements on the proposed method.

According to various embodiments, a system for operating a hatch assembly of a motor vehicle is provided. It is essential here that the system is designed so as to carry out a proposed method. Reference can be made to all statements on the proposed method and on the proposed control assembly.

According to various embodiments, a motor vehicle, in particular for carrying out the proposed method, having a proposed system is provided. Reference can be made to all statements on the proposed method, the proposed control assembly, and the proposed system.

Various embodiments provide a method for operating a hatch assembly of a motor vehicle, in which a motorized drive assembly for opening and closing the hatch assembly in a motorized manner, a control assembly for actuating the drive assembly, and a sensor assembly, coupled with the control assembly, having at least one radar sensor for detecting sensor values are provided, wherein a contactless operating action of an operator located outside the motor vehicle is detected by the sensor assembly in a detection routine and the operating action is classified in a classification routine as an invalid operating action or valid operating action, wherein in the case of an invalid operating action, it is discarded and in the case of a valid operating action, a motorized opening procedure or a motorized closing procedure of the hatch assembly by the drive assembly is triggered, wherein a following action of the operator chronologically following the operating action is detected by the sensor assembly in the detection routine and that the operating action is classified in consideration of the following action in the classification routine.

In various embodiments, the following action comprises moving of the operator away from the motor vehicle and/or standing still of the operator, in particular in a specific distance spatial segment, and that the operating action is classified in consideration of the moving away and/or the standing still. In some embodiments, that the operating action is classified as a valid operating action in the classification routine if the following action comprises the standing still of the operator in a specific distance spatial segment.

In various embodiments, the following action, in particular chronologically before the moving away, includes a characteristic following pause, during which the operator does not move or moves more slowly than a defined first minimum speed and that the operating action is classified in consideration of the characteristic following pause.

In various embodiments, a preliminary action chronologically preceding the operating action is detected by the sensor assembly in the detection routine and that the preliminary action is taken into consideration in the classification of the operating action in the classification routine. In some embodiments, that the preliminary action comprises an approach of the operator to the motor vehicle, in particular in a specific approach spatial segment, and that the operating action is classified in consideration of the approach.

In various embodiments, the preliminary action, in particular after the approach, includes a characteristic preliminary pause, during which the operator does not move or moves more slowly than a defined second minimum speed and that the operating action is classified in consideration of the characteristic preliminary pause.

In various embodiments, the operating action is detected in the detection routine in that the sensor values detected by the sensor assembly are compared with a defined recognition criterion and that depending on the comparison with the recognition criterion, if the recognition criterion is at least partially met, the operating action is recognized as such. In some embodiments, the recognition criterion is at least partially defined by a time condition, location condition, speed condition, and/or direction condition.

In various embodiments, the operating action is classified in consideration of the following action in that the following action, in particular the sensor values detected by the sensor assembly after the operating action, are compared with a defined following criterion and that depending on the comparison with the following criterion, if the following criterion is at least partially met or not met, the operating action is classified as a valid operating action or invalid operating action. In some embodiments, the following criterion is at least partially defined by a time condition, location condition, speed condition, and/or direction condition.

In various embodiments, the preliminary action is taken into consideration in the classification of the operating action in the classification routine in that the preliminary action, in particular the sensor values detected by the sensor assembly before the operating action, is compared with a defined preliminary criterion, and that depending on the comparison with the preliminary criterion, if the preliminary criterion is at least partially met or not met, the operating action is classified as a valid operating action or invalid operating action. In some embodiments, the preliminary criterion is at least partially defined by a time condition and/or a location condition and/or a speed condition and/or a direction condition.

In various embodiments, the classification routine takes place in multiple steps as needed and that in a first classification step of the classification routine, the following action is compared with an absolute condition of the following criterion and that depending on the comparison, the operating action is classified either as a valid operating action or in a second classification step of the classification routine, the following action is compared with a further condition of the following criterion and/or the operating action is compared with a condition of an operating criterion and/or the preliminary action is compared with a condition of the preliminary criterion.

In various embodiments, in the first classification step, the absolute condition defines that the operating action is classified as a valid operating action if the following action comprises standing still in a specific distance spatial segment.

In various embodiments, in the second classification step, the further condition of the following criterion is a time condition and that the time condition of the following criterion defines that the operating action is classified as a valid operating action if the following action includes the characteristic following pause or if the characteristic following pause has specific properties, and/or wherein the second classification step, the condition of the preliminary criterion is a time condition and that the time condition of the preliminary criterion is at least partially defined in that the operating action is classified as a valid operating action if the preliminary action includes the characteristic preliminary pause or if the characteristic preliminary pause has specific properties.

In various embodiments, the following action comprises a movement sequence, which is detected in the detection routine by the sensor assembly, in that in consideration of the sensor values detected by the sensor assembly after the operating action, a following trajectory is ascertained. In some embodiments, the operating action comprises a movement sequence, which is detected in the detection routine by the sensor assembly, in that an operating trajectory is ascertained on the basis of the sensor values detected by the sensor assembly during the operating action, and/or that the preliminary action comprises a movement sequence, which is detected in the detection routine by the sensor assembly, in that a preliminary trajectory is ascertained on the basis of the sensor values detected by the sensor assembly before the operating action.

Various embodiments provide a control assembly for a motorized hatch assembly of a motor vehicle, for coupling with a sensor assembly, which includes at least one radar sensor for detecting sensor values and which, in a detection routine, detects a contactless operating action of an operator located outside the motor vehicle, wherein the control assembly classifies the operating action in a classification routine as an invalid operating action or valid operating action, wherein the control assembly discards it in the case of an invalid operating action and triggers a motorized opening procedure or a motorized closing procedure of the hatch assembly via the drive assembly in the case of a valid operating action, wherein the control assembly classifies the operating action in the classification routine in consideration of a following action, which is detected by the sensor assembly in the detection routine and chronologically follows the operating action.

Various embodiments provide a system for operating a hatch assembly of a motor vehicle having control assembly, sensor assembly, and drive assembly wherein the system is designed so as to carry out a method as described herein.

Various embodiments provide a motor vehicle having a system as described herein.

### BRIEF DESCRIPTION OF THE DRAWINGS

Various aspects will be explained in more detail hereinafter on a drawing, which solely illustrates exemplary embodiments. In the drawing

FIG. 1 shows a detail of a proposed motor vehicle having a proposed system in a side view and

FIG. 2 shows the motor vehicle according to FIG. 1 in a top view, wherein an operator in a) carries out an operating action and a following action, and b) carries out an operating action and a following action different from a), and in c) carries out a preliminary action, an operating action, and a following action.

### DETAILED DESCRIPTION

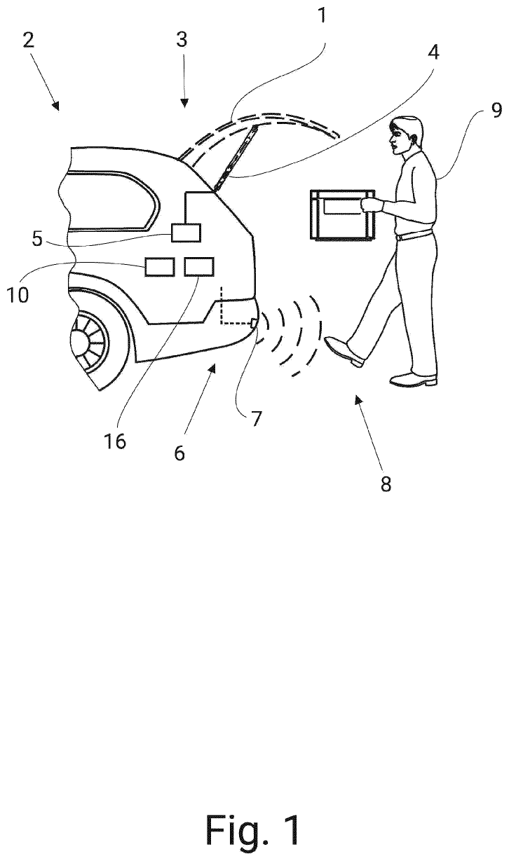

The exemplary embodiment shown in the figures and disclosed below can be related to a method for operating a hatch assembly 1 of a motor vehicle 2. A motor vehicle 2 is shown by way of example in FIG. 1.

In the method, a motorized drive assembly 4, a control assembly 5, and a sensor assembly 6 having at least one radar sensor 7 are provided.

The hatch assembly 1 can be opened and closed in a motorized manner via the motorized drive assembly 4, depending on the status of the hatch assembly 1. If the hatch assembly 1 is in an open status, for example, it can be closed via the drive assembly 4. In contrast, if the hatch assembly 1 is in a closed status, it can be opened via the drive assembly 4.

The drive assembly 4 is actuatable via the control assembly 5. The drive assembly 4 can be functionally coupled with the control assembly 5 for this purpose. The control assembly 5 can be, for example, part of a central control assembly of the motor vehicle 2 or a control assembly 5 which is formed separately, thus is different from the central control assembly.

The control assembly 5 is coupled, in particular functionally, with the sensor assembly 6. The sensor assembly 6 detects sensor values, on the basis of which the control assembly 5 can actuate the drive assembly 4. The sensor assembly 6 accordingly has one or more radar sensors 7 for detecting sensor values.

In the method, in a detection routine, a contactless operating action 8 of an operator 9 located outside the motor vehicle 2 is detected by the sensor assembly 6, in particular by the radar sensor 7 or the radar sensors 7. The operating action 8 takes place in a contactless manner with respect to the motor vehicle 2, in particular with respect to the control assembly 5, the sensor assembly 6, and the hatch assembly 1. The contactless operating action 8 of the operator 9, who is located at the rear side outside motor vehicle 2, is shown by way of example in FIG. 1.

As a reaction to the operating action 8, a motorized opening procedure or a motorized closing procedure of the hatch assembly 1 by the drive assembly 4 can be triggered. For this purpose, the control assembly 5 can actuate the drive assembly 4 accordingly. This is indicated in FIG. 1 by the dashed line of the hatch assembly 1, represents its open position.

To avoid any incorrect triggering, thus inadvertent opening and closing procedures, in the method, the operating action 8 is classified as an invalid operating action 8, which took place inadvertently, for example, or valid operating action 8, which took place deliberately, for example, in a classification routine. The classification can be carried out, for example, by a classification unit 10, which can be comprised by the control assembly 5 or the sensor assembly 6.

In the event of an invalid operating action 8, it is discarded, for example, by the classification unit 10, and in the event of a valid operating action 8, the opening procedure or the closing procedure of the hatch assembly 1 is triggered. Whether a motorized opening or closing procedure is thus triggered in reaction to the operating action 8 accordingly takes place depending on the occurring classification.

It is now essential that a following action 11 of the operator 9 chronologically following the operating action 8 in the detection routine is detected by the sensor assembly 6 and that the operating action 8 is classified in consideration of the detected following action 11 in the classification routine. The following action 11 can directly chronologically follow the operating action 8.

It is possible that the following action 11 comprises a duration of less than 5 seconds, or less than 3 seconds. During the following action 11, the operator 9 can continue to be located outside the motor vehicle 2. Incorrect triggering can be reliably avoided by consideration of the detected following action 11 in the classification of the operating action 8 as a valid or invalid operating action 8. The classification routine can chronologically follow the detection routine or can be at least partially superimposed therewith.

Very generally, the operating action 8 can comprise a movement sequence of the operator 9. It can be provided that the operating action 8 comprises an operating gesture of the operator 9. The operating gesture can be, for example, a specific movement which the operator 9 carries out. It is possible in particular that the operating gesture is executed by a foot, for example, as a kicking movement, or by a hand of the operator 9, in particular to trigger the motorized opening procedure or the motorized closing procedure of the hatch assembly 1.

The operating action 8, in particular the operating gesture, can take place in a specific operating spatial segment 12. The operating spatial segment 12 is a defined area in which the operating action 8 is detectable by the sensor assembly 6 when the operating gesture takes place accordingly. Operating actions 8 taking place outside the operating spatial segment 12 are either not detected or are discarded as invalid operating actions 8. It is possible that the operating spatial segment 12 comprises an area between the sensor assembly 6, in particular the radar sensor 7, and a specific distance, such as a meter, or 50 cm, in relation to the sensor assembly 6, in particular the radar sensor 7.

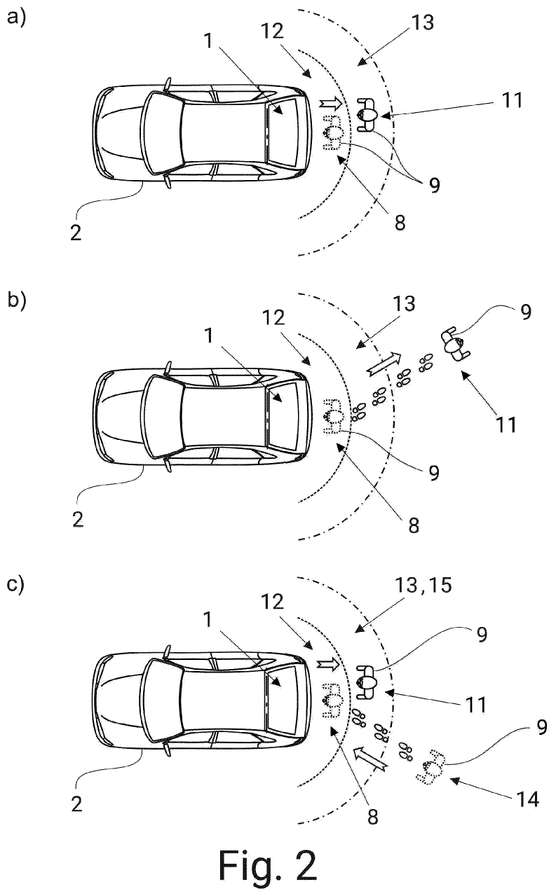

As shown by way of example in FIG. 1, the operator 9 raises his foot in the direction of the motor vehicle 2 as the operating gesture. This takes place in a specific operating spatial segment 12, in which the sensor assembly 6 or the radar sensor 7 detects the operating gesture. The operating spatial segment 12 comprises an area between the sensor assembly 6 or the radar sensor 7 and a specific distance with respect to the sensor assembly 6 or the radar sensor 7 here. The operating spatial segment 12 can also be seen by way of example in FIGS. 2a), 2b), and 2c).

The following action 11 can also very generally comprise a movement sequence of the operator 9 which takes place chronologically after the operating action 8. It can be provided that the following action 11 comprises a movement of the operator 9 away from the motor vehicle 2 and/or the sensor assembly 6, in particular from the radar sensor 7. During the movement away, the distance increases between the operator 9 and the motor vehicle 2 and/or the sensor assembly 6, in particular the radar sensor 7. It is additionally or alternatively possible that the following action 11 comprises the operator 9 standing still. During the standing still, the distance essentially does not change between the operator 9 and the motor vehicle 2 or the sensor assembly 6, in particular the radar sensor 7. It is conceivable in particular that the following action 11 comprises both moving away and standing still, for example, if the operator 9 initially steps back a few steps after the operating action 8 and then waits for the motorized opening or closing of the hatch assembly 1.

The following action 11, in particular the moving away and/or the standing still, can take place in a specific distance spatial segment 13. The distance spatial segment 13 is a defined area in which the following action 11 is detectable by the sensor assembly 6. Following actions 11 taking place outside the distance spatial segment 13 are either not detected or are discarded as invalid. The distance spatial segment 13 can overlap, in particular partially, with the operating spatial segment 12. It is possible that the distance spatial segment 13 is bounded on one side at a specific distance, such as 1 m, 2 m, or 3 m, in relation to the sensor assembly 6, in particular the radar sensor 7.

The distance spatial segment 13 is depicted in each of FIGS. 2a), 2b), and 2c). The following action 11 comprises moving away and chronologically following standing still (FIGS. 2a), 2c)) and moving away (FIG. 2b)).

If the following action comprises moving away and/or standing still, it can be provided that the operating action 8 is classified in consideration of the moving away and/or standing still. It is possible in particular here that the operating action 8 is classified as a valid operating action in the classification routine if the following action 11 comprises the operator 9 standing still in a specific distance spatial segment. In particular, the specific distance spatial segment can define a specific distance of the operator 9 from the sensor assembly 6 and/or from the motor vehicle 2.

The following action 11 can include a characteristic following pause. During the characteristic following pause, the operator 9 does not move or moves more slowly than a defined minimum speed. The operating action 8 can be classified in consideration of the characteristic following pause. It can be possible that the characteristic following pause takes place chronologically before the moving away. The characteristic following pause can take place chronologically after the operating action 8.

In various embodiments it can be provided that a preliminary action 14 chronologically preceding the operating action 8 is detected by the sensor assembly 6, in particular by the radar sensor or sensors 7, in the detection routine. The detected sensor values which are detected chronologically before the operating action 8 can be assigned to the preliminary action 14. In order to further optimize a classification of the operating action 8, the preliminary action 14 can be taken into consideration, in particular in addition to the following action 11, in the classification of the operating action 8 in the classification routine.

The operating action 8 can chronologically directly follow the preliminary action 14. The preliminary action 14 can very generally comprise a movement sequence which takes place before the operating action 8. It can be the case with respect to the preliminary action 14 that the preliminary action 14 comprises an approach of the operator 9 toward the motor vehicle 2 and/or toward the sensor assembly 6, in particular the radar sensor 7, as shown by way of example in FIG. 2c). During the approach, the distance decreases between the operator 9 and the motor vehicle 2 and/or the sensor assembly 6, in particular the radar sensor 7. The approach is distinguished by a movement speed in the direction of the sensor assembly 6 and can be detected thereby. The operating action 8 can be classified in consideration of the approach.

The preliminary action 14, in particular the approach, can take place in a specific approach spatial segment 15. The approach spatial segment 15 is a defined area in which the preliminary action 14 is detectable by the sensor assembly 6. Preliminary action 14 taking place outside the approach spatial segment 15 are either not detected or are discarded as invalid. The approach spatial segment 15 can overlap, in particular partially, with the operating spatial segment 12 and/or the distance spatial segment 13. The approach spatial segment 15 and the distance spatial segment 13 can comprise the same area. It is possible that the approach spatial segment 15 is delimited on one side at a specific distance, such as 1 m, 2 m, or 3 m, in relation to the sensor assembly 6, in particular the radar sensor 7. The approach spatial segment 15 can be inferred by way of example from FIG. 2c). The approach spatial segment 15 corresponds, in some embodiments, to the distance spatial segment 13.

The preliminary action 14 can include a characteristic preliminary pause, during which the operator 9 does not move or moves more slowly than a defined minimum speed. The operating action 8 can be classified in consideration of the characteristic preliminary pause. In particular, it is possible that the characteristic preliminary pause takes place chronologically after the approach. The characteristic preliminary pause can take place chronologically before the operating action 8.

The preliminary action 14, the operating action 8, and the following actions 11 can in particular be contactless, with respect to the motor vehicle 2 or the sensor assembly 6, in particular the radar sensor 7.

To be able to detect the operating action 8 reliably, it can be provided that the operating action 8 is detected in the detection routine, in that the sensor values detected by the sensor assembly 6, in particular by the radar sensor or sensors 7, are compared with a defined recognition criterion. The operating action 8 is recognized as such depending on the comparison with the recognition criterion in the case of at least partial fulfillment of the recognition criterion. If the detected sensor values fulfill the recognition criterion, the detected sensor values can be assigned to the operating action 8. It is possible that the comparison is carried out by a comparison unit 16, which can be comprised by the control assembly 5 or the sensor assembly 6. The recognition criterion can be at least partially defined by one or more conditions, in particular a time condition, a location condition, a speed condition, and/or a direction condition.

FIGS. 2a), 2b), and 2c) show by way of example that an operating action 8 is detected in the detection routine. The operating action 8 is carried out by the operator 9 (shown by dot-dash lines in FIG. 2a) to 2c)) in the form of a specific movement sequence and comprises, for example, an operating gesture, in various embodiments, a kicking movement with the foot. The sensor values detected during the operating gesture are compared with the recognition criterion and the operating action is recognized as such.

It can be provided that the operating action 8 is classified in consideration of the following action 11 in that the following action 11, in particular the sensor values detected by the sensor assembly 6 chronologically after the operating action 8, is compared with a defined following criterion. Depending on the comparison with the following criterion, in the case of at least partial fulfillment or nonfulfillment of the following criterion, the operating action 8 is classified as a valid operating action or invalid operating action. It is possible that the comparison is carried out by the comparison unit 16 or the classification unit 10. The sensor values detected by the sensor assembly 6 chronologically after the operating action 8 can be assigned to the following action 11. The following criterion can be at least partially defined by one or more conditions, in particular a time condition, a location condition, a speed condition, and/or a direction condition.

It is alternatively or additionally possible that the operating action 8 is classified in consideration of the operating action 8 itself in that the operating action 8, in particular the sensor values detected chronologically during the operating action 8 by the sensor assembly 6, is compared with a defined operating criterion. Depending on the comparison with the operating criterion, in the case of at least partial fulfillment or nonfulfillment of the operating criterion, the operating action 8 is classified as a valid operating action or invalid operating action. It is possible that the comparison is carried out by the comparison unit 16 or the classification unit 10. It can be provided that the operating criterion is at least partially defined by one or more conditions, in particular a time condition, a location condition, a speed condition, and/or a direction condition.

Furthermore, alternatively or additionally, it can be provided that the preliminary action 14 is taken into consideration in the classification of the operating action 8 in the classification routine in that the preliminary action 14, in particular the sensor values detected by the sensor assembly 6 chronologically before the operating action 8, is compared with a defined preliminary criterion. Depending on the comparison with the preliminary criterion, in the case of at least partial fulfillment or nonfulfillment of the preliminary criterion, the operating action 8 is classified as a valid operating action or invalid operating action. It is possible that the comparison is carried out by the comparison unit 16 or the classification unit 10. The sensor values detected by the sensor assembly 6 chronologically before the operating action 8 can be assigned to the preliminary action 14. The preliminary criterion can be defined at least partially by one or more conditions, in particular a time condition, a location condition, a speed condition, and/or a direction condition.

The comparison of the detected sensor values can vary generally relate to unprocessed and/or preprocessed sensor values and in particular all items of information of the sensor values, partial items of information of the sensor values, and/or individual items of information of the sensor values.

In the depictions of FIGS. 2a) and 2b), the classification routine which has respectively taken place results in different classifications of the operating action 8. The operating action 8 is classified in the classification routine in consideration of the following routine by comparison with a following criterion. In the embodiment according to FIG. 2a), the following action 11 of the operator 9 (shown by solid lines) comprises moving away in the form of stepping back from the motor vehicle 2 or the sensor assembly 6 and standing still. The following criterion is defined such that the operating action 8 is classified by the classification unit 10 as a valid operating action 8 and the opening procedure or closing procedure is triggered. In the embodiment according to FIG. 2b), the following action 11 of the operator 9 (shown by solid lines) comprises moving away in the form of walking away from the motor vehicle 2 or the sensor assembly 6. The following criterion is defined such that the operating action 8 is classified here by the classification unit 10 as an invalid operating action 8 and is discarded. In the depiction of FIG. 2c), in addition to the operating action 8 and the following action 11, the preliminary action 14 is also detected and this is taken into consideration accordingly in the classification.

With respect to the time conditions, the location conditions, the speed conditions, and the direction conditions of the respective criteria it is conceivable that the condition or the conditions of the recognition criterion, the following criterion, the operating criterion, and the preliminary criterion are identical, partially identical, or different.

A “time condition” can be, for example, a condition with respect to a time duration. It is conceivable that the time condition defines a minimum and/or maximum duration for the corresponding action. For example, it is possible that the time condition of the recognition criterion defines that a movement sequence cannot fall below a minimum duration and/or cannot exceed a maximum duration so that the movement sequence is recognized or detected as an operating action 8, in particular as an operating gesture. It is also conceivable that the time condition defines one or more movement pauses, such as a characteristic following cause and/or a characteristic preliminary pause, for the corresponding action. For example, it is possible that the time condition of the following criterion, the operating criterion, or the preliminary criterion defines one or more movement pauses, such as a characteristic following cause and/or a characteristic preliminary pause, for movement sequence of the corresponding action, in which the movement stops or falls below a minimum speed, and that the time condition is taken into consideration in the classification routine.

A “location condition” can be, for example, a condition with respect to an action location or stopping location. It is conceivable that the location condition defines a corresponding spatial segment, in particular an operating spatial segment 12, a distance spatial segment 13, or an approach spatial segment 15, within which the corresponding action can be carried out or is to be carried out. For example, it is possible that the location condition of the following criterion, the operating criterion, or the preliminary criterion defines a movement sequence of the corresponding action within the corresponding spatial segment and that the location condition is taken into consideration in the classification routine. For example, it is likewise possible that the location condition of the recognition criterion defines that a movement sequence has to take place within a recognition spatial segment so that the movement sequence is recognized as an operating action 8.

It can be seen from FIGS. 2a), 2b), and 2c), for example, that the operating action 8 by the operator 9 (shown by dotted lines) has to take place in a specific operating spatial segment 12 said that the operating action 8 is recognized as such. If the following action 11 comprises moving away and standing still in the distance spatial segment 13, the operating action 8 is classified as reliable (FIGS. 2a), 2c)). If the following action 11 comprises moving away out of the distance spatial segment 13, the operating action 8 is discarded as unreliable (FIG. 2b)).

A “speed condition” can be, for example, a condition with respect to an action speed. It is conceivable that the speed condition defines a minimum and/or maximum speed at which the corresponding action can be carried out or is to be carried out. For example, it is possible that the speed condition of the recognition criterion defines that a movement sequence has to exceed a minimum speed and/or has to fall below a maximum speed so that the movement sequence is recognized as an operating action 8. It is also conceivable that the movement speed defines a stopping and/or starting speed, at which the corresponding action respectively ends or begins. For example, it is conceivable that the speed condition of the following criterion, the operating criterion, or the preliminary criterion defines a slowing and/or an acceleration of the movement sequence of the corresponding action and that the speed condition is taken into consideration in the classification routine.

A “direction condition” can be, for example, a condition with respect to an action direction. It is conceivable, for example, that the direction condition defines a range of directions from which the corresponding action can be carried out or is to be carried out.

It is conceivable in conjunction with all of the criteria that at least one condition, thus a time condition, a location condition, a speed condition, and/or a direction condition, represents an absolute condition, the sole fulfillment or nonfulfillment of which results in an unambiguous classification of the operating action 8 as a valid or invalid operating action 8 in the classification routine. In this case, the further conditions can remain unconsidered in the classification of the operating action 8 in the classification routine. For example, it is conceivable that an absolute condition of the following criterion defines that for the case that the following action 11 comprises standing still, in particular in a specific distance spatial segment 13, the operating action 8 is classified in the classification routine as a valid operating action 8.

Alternatively or additionally, it is possible in conjunction with all of the criteria that multiple conditions are taken into consideration in the classification routine, equally or with different weightings. For example, it is possible that a condition of the preliminary criterion is not met, a condition of the following criterion and a condition of the actuating criterion are met, and the operating action 8 is classified in the classification routine as a valid operating action 8.

In various embodiments it is provided that the classification routine takes place in multiple steps as needed, thus if required. In a first classification step of the classification routine, the following action 11 is initially compared with an absolute condition of the following criterion. Depending on this comparison, the operating action 8 is either classified as a valid operating action 8 or a second classification step takes place. In the second classification step of the classification routine, the following action 11 is compared with a further condition of the following criterion and/or the operating action 8 is compared with a condition of the operating criterion and/or the preliminary action 14 is compared with a condition of the preliminary criterion. If the first classification step therefore does not result in an unambiguous valid classification, the second classification step does takes place. The classification routine insofar takes place—as needed—in one or multiple steps depending on the first classification step.

In the exemplary embodiments of FIGS. 2a) and 2c), the first classification step having an absolute condition of the following criterion can already result in a reliable classification of the operating action 8. In various embodiments, the absolute condition can define for the first classification step that the operating action 8 is classified as a valid operating action if the following action 11 comprises standing still, in particular in a specific distance spatial segment 13.

In the exemplary embodiment of FIG. 2b), the following action 11 does not comprise standing still of the operator 9. The first classification step therefore cannot result here in a reliable classification of the operating action 8. This is because it is conceivable, for example, that the operator 9, after a deliberate operating action 8, immediately wishes to move away from the motor vehicle 2 and does not wait for the reaction to his operating action 8, in the form of standing still. Nonetheless, the deliberate operating action 8 would be classified as a valid operating action 8. In various embodiments, the second classification step can compare the following action 11 with a further condition of the following criterion and/or the operating action 8 with a condition of the operating criterion. If the preliminary action 14 is also detected, the preliminary action 14 can also be compared with a condition of the preliminary criterion. The operating action 8 can then accordingly be classified reliably on the basis of the comparison or the comparisons of the second classification step.

It is possible in particular that in the second classification step, the further condition of the following criterion is a time condition and that the time condition of the following criterion defines that the operating action 8 is classified as a valid operating action if the following action 11 has the characteristic following pause or if the characteristic following pause has specific properties. It is thus possible, for example, that the mere recognition or occurrence of a characteristic following pause already leads to the result that the operating action 8 is or can be classified as valid. However, it is likewise possible that the characteristic following cause has to have specific properties so that the operating action 8 is classified as a valid operating action. Such specific properties can be absolute properties, for example, that the following pause meets a specific minimum duration or maximum duration, and/or relative properties, for example, that the following pause has a specific, in particular chronological minimum ratio or, in particular chronological, maximum ratio. It is conceivable, for example, that the specific properties comprise a specific ratio of the characteristic following pause in relation to the characteristic preliminary pause, a specific time value, etc.

Alternatively or additionally, it is possible that in the second classification step, the condition of the preliminary criterion is a time condition and that the time condition of the preliminary criterion is at least partially defined in that the operating action 8 is classified as a valid operating action if the preliminary action has the characteristic preliminary pause or if the characteristic preliminary pause has specific properties. It is thus possible, for example, that the mere recognition or occurrence of a characteristic preliminary pause already leads to the result that the operating action 8 is classified as valid. However, it is likewise possible that the characteristic preliminary pause has to have specific properties so that the operating action 8 is or can be classified as a valid operating action. Such specific properties can be absolute properties, for example, that the preliminary pause meets a specific minimum duration or maximum duration, and/or relative properties, for example, that the preliminary pause has a specific, in particular chronological, minimum ratio or, in particular chronological, maximum ratio. It is conceivable, for example, that the specific properties comprise a specific ratio of the characteristic preliminary pause in relation to the characteristic following pause, a specific time value, etc.

Very generally, it has been established that deliberate operating actions 8 differ from inadvertent operating actions 8, among other things, for example, in that the preliminary action 14 can have a characteristic preliminary pause chronologically after the approach and/or that the following action 11 can have a characteristic following pause chronologically before the moving away. A characteristic pause, thus a characteristic following pause or a characteristic preliminary pause, can be understood here as a period of time in which the operator 9 does not move or moves more slowly than a defined minimum speed. It is accordingly conceivable that in the second classification step, the following action 11 is compared with a time condition of the following criterion which relates in particular to the characteristic following pause before the moving away, and/or the preliminary action 14 is compared with a time condition of the preliminary criterion which relates in particular to the characteristic pause after the approach.

Furthermore, it can be provided that the detection routine is triggered if the sensor values detected by the sensor arrangement 6 before the detection routine meet a defined detection start criterion. Incorrect triggering can already be avoided in this way in that the detection routine only starts when the defined detection start criterion is met. The detection start criterion can be at least partially defined in that an object detected by the sensor assembly 6 contains an extension specification representative of an operator 9, in particular a minimum size and/or a predetermined outline. The detection routine insofar only starts if the detected object has a specific minimum size and/or a specific outline, by which possible incorrect triggering by animals or children, for example, can be avoided. The meeting of the detection start criterion can be checked by the control unit, by the sensor arrangement 6, or by the comparison unit 16.

Alternatively or additionally, it can be provided that the detection start criterion is at least partially defined in that the operator 9 detected by the sensor arrangement 6 stops in a specific spatial segment, in particular in the approach spatial segment 15 or in the operating spatial segment 12, and/or falls below a specific distance to the motor vehicle 2 and/or has a specific movement speed and/or has a specific movement direction. In the exemplary embodiments according to FIGS. 2a) and 2b), the detection start criterion is defined in that the operator 9 stopped in the operating spatial segment 12. In the embodiment according to FIG. 2c), the detection start criterion is defined in that the operator 9 approaches and enters the approach spatial segment 15.

In addition to a detection start criterion, it can be provided that the detection routine is ended when the sensor values detected by the sensor assembly 6 the detection routine meet a defined detection end criterion. It is conceivable that the detection end criterion is at least partially defined in that the operator 9 detected by the sensor assembly 6 stops in a specific spatial segment, in particular in the distant spatial segment 13, and/or exceeds a specific distance to the motor vehicle 2 and/or has a specific movement speed and/or has a specific movement direction. Alternatively or additionally, it is possible that the detection end criterion is at least partially defined in that a specific duration after detection of the operating action 8 has passed. In this case, the detection routine is defined to a specific time. The fulfillment of the detection end criterion can be checked by the control unit, by the sensor assembly 6, or by the comparison unit 16.

In particular the beginning of the preliminary action or the operating action and the end of the following action can be determined or defined by the detection start criterion and the detection end criterion.

In the exemplary embodiments according to FIGS. 2a) and 2c), the detection end criterion is defined in that the operator 9 stops in the distance spatial segment 13 and has fallen below a specific minimum speed, in various embodiments that the operator 9 stops essentially unmoving. In the embodiment according to FIG. 2b), the detection end criterion is defined in that the operator 9 moves out of the distance spatial segment 13.

Furthermore, it can be provided that the following action 11 has a movement sequence which is detected in the detection routine by the sensor assembly 6 in that in consideration of the sensor values detected by the sensor assembly 6 after the operating action 8, a following trajectory is ascertained. The operating action 8 can have a movement sequence which is detected in the detection routine by the sensor assembly 6 in that an actuator trajectory is ascertained on the basis of the sensor values detected by the sensor assembly 6 during the operating action 8. Alternatively or additionally, it can be provided that the preliminary action 14 has a movement sequence which is detected in the detection routine by the sensor assembly 6 in that a preliminary trajectory is ascertained on the basis of the sensor values detected by the sensor assembly 6 before the operating action 8. It is possible in this context that the following criterion, the operating criterion, and/or the preliminary criterion have or has trajectory conditions in each case.

In this aspect, reference is made to the application DE 10 2021 114 557 A1 of the prior art, the content of which is hereby incorporated in this application.

With respect to the sensor values, it can be provided that the detected sensor values include location information and/or movement speeds and/or movement directions of the operator 9 and/or a body part of the operator 9, in particular in one or more spatial segments, on the basis of which the operating action 8 and/or the following action 11 and/or the preliminary action 14 are detected. The location information and/or the movement speeds and/or the movement directions are detected here depending on the time. Location information can include, for example, the distance of the operator 9 to the sensor assembly 6, in particular the radar sensor 7, and/or the stopping location of the operator 9. Movement speeds can include, for example, the movement speed of the operator 9, in particular during the preliminary action 14, the operating action 8, and/or the following action 11, and/or the movement speed of an operating gesture.

The sensor assembly 6, in particular the radar sensor or sensors 7, can be put into an idle mode when a specific idle criterion is met and the idle mode is ended when a specific wake-up criterion is present. In this way, sensor values can be detected as needed by the sensor assembly 6, namely only when valid operating actions 8 are possible at all. It is conceivable that the wake-up criterion corresponds to the detection start criterion and/or that the idle criterion corresponds to the detection end criterion. The idle mode is ended in FIGS. 1, 2a), 2b), and 2c).

It can be possible in this context that the idle criterion is at least partially defined by the driving of the motor vehicle 2. During the driving of the motor vehicle 2, no valid operating actions 8 take place in any case, because of which the detection of sensor values is not necessary. Alternatively or additionally, it is possible that the idle criterion is at least partially defined by the nonexistence of an input signal, in particular an input signal emitted by a vehicle key. Incorrect triggering by unauthorized operators 9 can thus be prevented, for example, in that the sensor assembly 6 does not detect sensor values and accordingly does not detect operating actions 8 without a corresponding input signal. Furthermore, alternatively or additionally, it is possible that the wake-up criterion is at least partially defined by the existence of an input signal, in particular an input signal emitted by a motor vehicle key.

The sensor assembly 6 can be put into the idle mode independently or by the control assembly 5, for example. The meeting of the idle criterion and the meeting of the wake-up criterion can be checked, for example, by the control assembly 5, by the sensor assembly 6, or by the comparison unit 16.

According to a further teaching, a control assembly 5 is proposed which is for a motorized hatch assembly 1 of a motor vehicle 2 for coupling with a sensor assembly 6, which has at least one radar sensor 7 for detecting sensor values and which in a detection routine detects a contactless operating action 8 of an operator 9 located outside the motor vehicle 2. The control assembly 5 classifies the operating action in a classification routine as an invalid operating action or valid operating action, wherein the control assembly 5 discards it in the case of an invalid operating action and triggers a motorized opening procedure or a motorized closing procedure of the hatch assembly 1 via the drive assembly 4 in the case of a valid operating action 8. It is essential that the control assembly 5, in the classification routine, classifies that operating action 8 in consideration of a following action 11, which is detected by the sensor assembly 6 in the detection routine and chronologically follows the operating action.

Furthermore, a system 3 is proposed for operating a hatch assembly 1 of a motor vehicle 2 having control assembly 5, sensor assembly 6, and drive assembly 4. It is essential that the system 3 is designed so as to carry out the proposed method. A proposed system 3 is depicted by way of example in FIG. 1. Reference can be made to statements on the proposed method and the proposed control assembly 5.

The sensor assembly 6 of the system 3 can include one or more radar sensors 7. The system 3 can include a classification unit 10. The system 3 furthermore can include a comparison unit 16.

In addition to the method and the system 3, furthermore a motor vehicle 2 having a proposed system 3 is proposed. Reference can be made to all statements on the proposed method, the proposed control assembly 5 and the proposed system 3. A proposed motor vehicle 2 is partially shown in FIG. 1.

1. A method for operating a hatch assembly of a motor vehicle, in which a motorized drive assembly for opening and closing the hatch assembly in a motorized manner, a control assembly for actuating the drive assembly, and a sensor assembly, coupled with the control assembly, having at least one radar sensor for detecting sensor values are provided,
wherein a contactless operating action of an operator located outside the motor vehicle is detected by the sensor assembly in a detection routine and the operating action is classified in a classification routine as an invalid operating action or valid operating action, wherein in the case of an invalid operating action, it is discarded and in the case of a valid operating action, a motorized opening procedure or a motorized closing procedure of the hatch assembly by the drive assembly is triggered,
wherein a following action of the operator chronologically following the operating action is detected by the sensor assembly in the detection routine and that the operating action is classified in consideration of the following action in the classification routine.

2. The method according to claim 1, wherein the following action comprises moving of the operator away from the motor vehicle and/or standing still of the operator, in particular in a specific distance spatial segment, and that the operating action is classified in consideration of the moving away and/or the standing still.

3. The method according to claim 1, wherein the following action includes a characteristic following pause, during which the operator does not move or moves more slowly than a defined first minimum speed and that the operating action is classified in consideration of the characteristic following pause.

4. The method according to claim 1, wherein a preliminary action chronologically preceding the operating action is detected by the sensor assembly in the detection routine and that the preliminary action is taken into consideration in the classification of the operating action in the classification routine.

5. The method according to claim 4, wherein the preliminary action includes a characteristic preliminary pause, during which the operator does not move or moves more slowly than a defined second minimum speed and that the operating action is classified in consideration of the characteristic preliminary pause.

6. The method according to claim 1, wherein the operating action is detected in the detection routine in that the sensor values detected by the sensor assembly are compared with a defined recognition criterion and that depending on the comparison with the recognition criterion, if the recognition criterion is at least partially met, the operating action is recognized as such.

7. The method according to claim 1, wherein the operating action is classified in consideration of the following action in that the following action is compared with a defined following criterion and that depending on the comparison with the following criterion, if the following criterion is at least partially met or not met, the operating action is classified as a valid operating action or invalid operating action.

8. The method according to claim 4, wherein the preliminary action is taken into consideration in the classification of the operating action in the classification routine in that the preliminary action is compared with a defined preliminary criterion, and that depending on the comparison with the preliminary criterion, if the preliminary criterion is at least partially met or not met, the operating action is classified as a valid operating action or invalid operating action.

9. The method according to claim 7, wherein the classification routine takes place in multiple steps as needed and that in a first classification step of the classification routine, the following action is compared with an absolute condition of the following criterion and that depending on the comparison, the operating action is classified either as a valid operating action or in a second classification step of the classification routine, the following action is compared with a further condition of the following criterion and/or the operating action is compared with a condition of an operating criterion and/or the preliminary action is compared with a condition of the preliminary criterion.

10. The method according to claim 9, wherein, in the first classification step, the absolute condition defines that the operating action is classified as a valid operating action if the following action comprises standing still in a specific distance spatial segment.

11. The method according to claim 9, wherein, in the second classification step, the further condition of the following criterion is a time condition and that the time condition of the following criterion defines that the operating action is classified as a valid operating action if the following action includes the characteristic following pause or if the characteristic following pause has specific properties, and/or
wherein the second classification step, the condition of the preliminary criterion is a time condition and that the time condition of the preliminary criterion is at least partially defined in that the operating action is classified as a valid operating action if the preliminary action includes the characteristic preliminary pause or if the characteristic preliminary pause has specific properties.

12. The method according to claim 1, wherein the following action comprises a movement sequence, which is detected in the detection routine by the sensor assembly, in that in consideration of the sensor values detected by the sensor assembly after the operating action, a following trajectory is ascertained.

13. A control assembly for a motorized hatch assembly of a motor vehicle, for coupling with a sensor assembly, which includes at least one radar sensor for detecting sensor values and which, in a detection routine, detects a contactless operating action of an operator located outside the motor vehicle,
wherein the control assembly classifies the operating action in a classification routine as an invalid operating action or valid operating action, wherein the control assembly discards it in the case of an invalid operating action and triggers a motorized opening procedure or a motorized closing procedure of the hatch assembly via the drive assembly in the case of a valid operating action,
wherein the control assembly classifies the operating action in the classification routine in consideration of a following action, which is detected by the sensor assembly in the detection routine and chronologically follows the operating action.

14. A system for operating a hatch assembly of a motor vehicle having control assembly, sensor assembly, and drive assembly
wherein the system is designed so as to carry out a method according to claim 1.

15. A motor vehicle having a system according to claim 14.

16. The method according to claim 2, wherein the operating action is classified as a valid operating action in the classification routine if the following action comprises the standing still of the operator in a specific distance spatial segment.

17. The method according to claim 4, wherein the preliminary action comprises an approach of the operator to the motor vehicle and that the operating action is classified in consideration of the approach.

18. The method according to claim 6, wherein the recognition criterion is at least partially defined by a time condition, location condition, speed condition, and/or direction condition.

19. The method according to claim 7, wherein the following criterion is at least partially defined by a time condition, location condition, speed condition, and/or direction condition.

20. The method according to claim 8, wherein the preliminary criterion is at least partially defined by a time condition and/or a location condition and/or a speed condition and/or a direction condition.
